(19) United States
(12) Patent Application Publication
(10) Pub. No.: US 2016/0321259 A1
(43) Pub. Date: Nov. 3, 2016

(54) NETWORK INSIGHTS

(71) Applicant: Linkedln Corporation, Mountain View, CA (US)

(72) Inventors: Mathieu Bastian, San Francisco, CA (US); Matthieu F. Monsch, San Francisco, CA (US); Ada Cheuk Ying Yu, Santa Clara, CA (US)

(21) Appl. No.: 14/700,825

(22) Filed: Apr. 30, 2015

(51) Int. Cl. G06F 17/30; H04L 29/08

(52) U.S. Cl. CPC G06F 17/3053; H04L 67/306

(57) ABSTRACT

Network insights are bite-sized pieces of information about member's connections in the on-line social network that contain information that may be of interest to a viewing member but that is difficult or time-consuming to find. A network insights system generates and stores insights for each member in an on-line social network system. A network insights system also generates a set of personalization features for each member profile in the on-line social network. A set of personalization features for a member profile reflects the relevance of each possible value of a certain profile attribute with respect to the member profile. When a network insights system determines that a member (the viewer) is to be presented with one or more insights with respect to another member (the viewee) it selects insights of the viewee for presentation to the viewer based on the set of personalization features for the viewer.

### TECHNICAL FIELD

This application relates to the technical fields of software and/or hardware technology and, in one example embodiment, to system and method to produce network insights for a member in an on-line social network system.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to produce network insights for a member in an on-line social network system may be implemented;

FIG. 2 is block diagram of a system to produce network insights for a member in an on-line social network system, in accordance with one example embodiment;

FIG. 3 is a flow chart illustrating a method to produce network insights for a member in an on-line social network system, in accordance with an example embodiment; and

FIG. 4 is a diagrammatic representation of an example machine in the form of a computer system within which a set of instructions, for causing the machine to perform any one or more of the methodologies discussed herein, may be executed.

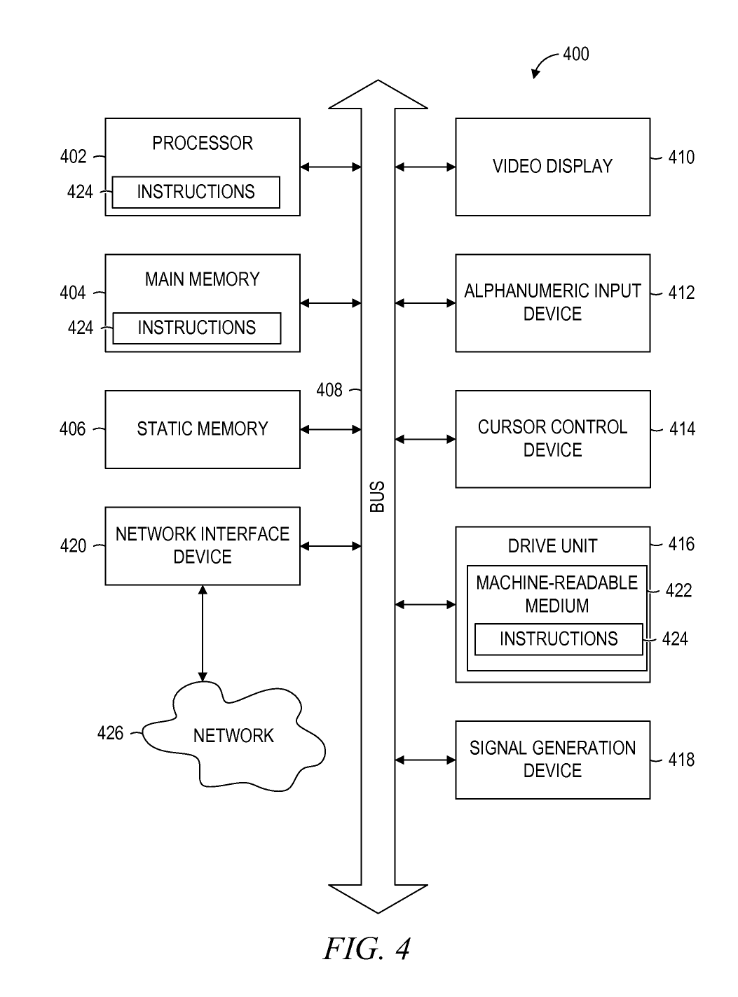

### DETAILED DESCRIPTION

A method and system to produce network insights for a member in an on-line social network system is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrases “an on-line social networking application” and “an on-line social network system” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network. Members that are connected in this way to a particular member may be referred to as that particular member's connections or as that particular member's network.

The profile information of a social network member may include various information such as, e.g., the name of the member, current and previous geographic location of the member, current and previous employment information of the member, information related to education of the member, information about professional accomplishments of the member, publications, patents, etc. The profile information of a social network member may also include information about the member's professional skills. A particular type of information that may be present in a profile, such as, e.g., company, industry, job position, etc., is referred to as a profile attribute. A profile attribute for a particular member profile may have one or more values. For example, a profile attribute may represent a company and be termed the company attribute. The company attribute in a particular profile may have values representing respective identifications of companies, at which the associated member has been employed. Other examples of profile attributes are the industry attribute and the region attribute. Respective values of the industry attribute and the region attribute in a member profile may indicate that the associated member is employed in the banking industry in San Francisco Bay Area.

In order to increase engagement among members, an on-line social network system may include a platform for providing so-called network insights. Network insights are bite-sized pieces of information about member's connections in the on-line social network. The member to whom the insights are to be presented is referred to as a viewer (as that member is the consumer of the insights), and the member who is the subject of the insights is referred to as a viewee (as the insights involving that member are being viewed). Network insights (or simply insights) may appear to a member who is a connection of Sherlock in the form as shown below.
“Sherlock knows 3 senior managers at PayPal.”
“6 of Sherlock's connections are working in San Francisco Bay Area.”
“Sherlock is connected to 10 more people at Twitter than you are.”
“Sherlock extends your network of people who know Hadoop by 35%.”

The goal of a network insight is to provide information to a member that may be of interest but that is difficult or time-consuming to find. An insight can also influence a viewing member to take an action. For example, if an insight indicates that a member's connection has recently added a new skill, the member may be motivated to add this same skill to their profile. An insight may be generated and selected in a way that is aimed at helping members to further leverage information accessible to them by virtue of their participation in an on-line social network, e.g., by explaining the value of every new connection, by surfacing new opportunities within their network, by suggesting specific actions (e.g., to connect to or to follow another member), etc. In one embodiment, the insights may be related to one specific viewee (e.g., as in the example “Sherlock knows 3 senior managers at PayPal,” which we may be referred to as descriptive insights), or relative to a viewer/viewee pair (e.g., as in the example “Sherlock is connected to 10 more people at Twitter than you are,” which we may be referred to as comparative insights). A network insight provides information with respect to a single value of a given profile attribute. For example the insight represented by the string “Sherlock knows 3 senior managers at PayPal” provides information with respect to only one value of the company attribute—the value that represents company “PayPal.” Similarly, the insight represented by the string “6 of Sherlock's connections are working in San Francisco Bay Area” provides information with respect to only one value of the region attribute—the value that represents San Francisco Bay Area region. It will be noted that an insight may provide information with respect to multiple profile attributes. For example, the insight represented by the string “6 of Sherlock's connections are working in the banking industry in San Francisco Bay Area” provides information with respect to one value of the region attribute—the value that represents San Francisco Bay Area region and information with respect to one value of the industry attribute—the value that represents the banking industry.

A platform for providing network insights may be referred to as a network insights system. It may be part of or cooperate with an on-line network system. In one embodiment, a network insights system generates and stores insights for each member in an on-line network system. The insights for a member profile may be scored based on their respective importance and stored in a database. The importance of an insight may be determined, e.g., based on how many connections are referenced in the insight. For example, the insight represented by the string “Sherlock knows 3 senior managers at PayPal” may have a lower importance score than the insight represented by the string “6 of Sherlock's connections are working in San Francisco Bay Area,” because the former insight references fewer connections than the latter one.

In some embodiments, insights may be generated with respect to not only member profiles, but with respect to other entities maintained in an on-line social network, such as companies, schools, etc. For example, an insight about a company may include information about jobs at the company, recently hired connections of the viewing member, etc. Insights may be presented in various contexts in an on-line social network, such as, e.g., in a member's profile or in a member's news feed.

The insights generated for respective member profiles of the on-line social network are stored in a database and may be periodically updated. In one embodiment, a set of insights for a member is updated only if an insights system determines that one or more trigger events took place since the last update. A trigger event may be, for example, a change to the member's profile or a change to a profile representing one of the member's connections.

A network insights system is also configured to generate a set of personalization features for each member profile in the on-line social network. While a network insight from the set of insights generated for a member profile is generated with respect to a single value of a given profile attribute, a set of personalization features for a member profile (referred to as a feature vector) reflects the relevance of each possible value of a certain profile attribute with respect to the member profile. The methodology for generating a feature vector is described further below.

When a network insights system determines that a member (the viewer) is to be presented with one or more insights with respect to another member (the viewee), the following sequence takes place. The network insights system retrieves from a database a certain number of insights for the viewee, based on their respective importance scores. For example, the network insights system may retrieve 50 top-scoring insights for the viewee. The network insights system then selects those insights that may be of most interest to the viewer and causes presentation of these selected insights on the viewer's display device. In one embodiment, the network insights system determines which insights are more relevant to the viewer and which insights are less relevant by comparing each insight to the feature vector of the viewer and generating respective relevance scores for the insights. The higher-scoring insights are identified as more relevant than the lower-scoring insights.

The network insights architecture may be divided into two parts: an offline component and an online component configured to communicate with each other based on what data that is being published to the insights database. As mentioned above, the offline component of the network insights system may be configured to periodically update respective collections of insights generated for member profiles of the on-line social network, e.g., on a daily basis. The online component may be configured to query the insights database and to serve selected network insights.

Various data that is used in generating network insights can be classified into three categories: profile information, standardized entities, and connection information. The profile information category includes information from member profiles, such as demographics, education records, skill records, position records, etc. As explained above, a type of data in a member profile may be referred to as a profile attribute that could have one or more values. For example, a skill attribute may have a value “design” or “research.”

The standardized entities category includes various entities such as companies, schools, industry, skills, etc. A standardized entity has a unique identifier within the on-line social network system and may be stored in a master list of entities of a certain type. For example, a master list of companies includes a unique identifier for each company in the list.

The connection information category includes a list of connections for each profile. Each profile in the on-line social network is identified by a unique identifier, and the connections of a member are represented by a list of identifiers representing their respective profiles. It will be noted, that, while the methodology described herein is used with respect to mutual connections, this methodology may also be utilized beneficially to an on-line social network that permits non-mutual connections, where one member is connected to another member in a certain way (e.g., receiving, in their news feed, the other member's posts) but is the other member is not connected to the first member in the same manner (e.g., the other member is not receiving, in their news feed, the first member's posts).

In one embodiment, the network highlights system generates network insights for a member profile in three steps. The first step prepares data by joining all the data related to a member profile into a single Profile object so it can be processed easily. The result of this step is a single Profile object for each member that contains profile attributes and their values (industry, positions, skills, etc.) and the list of connections. The values of profile attributes are represented using data associated with their respective standardized entities. For example, if the member identified by profile identification 1234 works at Oracle Corporation, the company attribute in that member's profile has a value that is the unique identifier assigned to Oracle Corporation entity in the on-line social network system, which is 1028. In some embodiments, a value of a profile attribute or a connection identification may be associated with a timestamp. For example, a connection identification included in a profile object generated for a member profile may be associated with a timestamp that indicates the time the two members became connected.

The second step aims to extend the Profile object so all the information related to each of the connected profiles. Connected profiles may be referred to as simply connections. Table 1 below illustrates an example of the result of step one, with respect to a member profile representing John (A) who has 2 connections: Mary (B) and Jennifer (C).

TABLE 1

| Profile A | Profile B | Profile C |
|---|---|---|
| Attributes about John | Attributes about Mary | Attributes about Jennifer |
| Connections: B, C | Connections: A | Connections: A |

Table 1 above represents three profile objects: Profile A, Profile B, and Profile C). Each of these three profiles contains a list of attributes for the associated member (e.g., profile attributes such as skills, companies, geographic region, etc.), as well as the list of connections. The result of the second step, that extends the profile object to include all the information related to each of the connected profiles, is shown in Table 2 below.

TABLE 2

| Profile A | | Profile B | Profile C |
|---|---|---|---|
| Attributes about John | | Attributes about Mary | Attributes about Mary |
| Connections: B, C | | Connections: A | Connections: A |
| Profile B | Profile C | Profile A | Profile A |
| Attributes | Attributes | Attributes about John | Attributes about John |
| about | about | Connections: B, C | Connections: B, C |
| Mary | Jennifer | | |
| Connec- | Connec- | | |
| tions: A | tions: A | | |

The third step may be described as transforming profile attributes in the profile objects into dimensions. During the third step, a network insights system processes an extended profile object (that includes information originally found in the member profile as well as the information from profiles connected to the member profile) to aggregate and count the member's connections over multiple dimensions. Dimensions represent respective profile attributes. For example, one dimension may represent a skills attribute and may be referred to as a skills dimension, while another dimension may represent a company attribute and may be referred to as a company dimension. A dimension generated during the third step includes specific values of a profile attribute that are present in one or more connected profiles. Each specific value is associated with the identifications of those connected profiles that include that specific value, as well as a count of those connected profiles that include that specific value.

For example, a skills dimension may be generated for a profile object to represent the skills attribute. This skills dimension would include keys that correspond to those specific values of the skills attribute that are present in at least one of the connections of the member represented by the profile object. Continuing with the example described with reference to Table 1 and Table 2 above, Profile B has skills “Design” and “Research” and Profile C has skill “Design.” Profile A is connected to Profile B and Profile C. A representation of the skills dimension generated for Profile A is illustrated in Table 3 below.

TABLE 3

| Key | Connections | Count |
|---|---|---|
| “Design” | B, C | 2 |
| “Research” | B | 1 |

The process of step 3 may be repeated over multiple dimensions (e.g., current position, industry, region, etc.) and may also support compound keys, such that a dimension may represent more than one profile attribute. For example, a dimension may include a key that represents a value for the industry attribute and a value for a region attribute, such as a key represented by the strings “Banking” and “San Francisco Bay Area.” The network insights system would then identify only those connections that indicate that the associated member is in the banking industry in San Francisco Bay Area.

In one embodiment, a network insights system includes so-called key extractors configured to determine whether a connection is to be identified as associated with a dimension key in a profile object. A key extractor takes a member profile as input and returns a list of keys. Each dimension is associated with a unique key extractor or a set of key extractors if the dimension is compound. This key extractor often implements additional filtering. For example, for a current company dimension, the key extractor only considers current positions and filters out past positions. Another common filtering is based on a time stamps, so that only recent events are considered. For instance, for a recently changed job dimension the associated key extractor may be configured to use a threshold that only include positions started within a certain period of time, e.g., in the last 3 months. The network insights system maintains a list of all the dimensions that need to be computed and the results are held in memory.

In step 3, the network insights system creates multiple dimensions, which are then used to generate network insights. Tables 4 and 5 below illustrate two example dimensions generated in step 3 for Profile A: “Current company” dimension and “Skills” dimension.

TABLE 4
Current Company

| Key | Connections | Count |
|---|---|---|
| “Google” | C | 1 |
| “Apple” | B | 1 |

TABLE 5
Skill

| Key | Connections | Count |
|---|---|---|
| “Design” | B, C | 2 |
| “Research” | B | 1 |

As shown in Table 3, Table 4, and Table 5, each row in a dimension contains a count field, which stores the number of connections that have the corresponding key (or keys if the key is a compound key) in their profile. The count may be used to determine relative importance of each key in a dimension and to sort the keys based on the determined relative importance of each key. The process of determining relative importance of each key may be referred to as a ranking step and may be performed by a ranker module of the network insights system. The ranker module (or simply ranker) may utilize a scoring function that may be configured, e.g., to use the count itself as a score or operate a transformation using the count and additional metadata. An example of a transformation would be to use the ratio of connections rather than the absolute count. Another example would be to use a global frequency score to penalize very popular keys. For instance, one could have the overall frequency of each value of the skill attribute and use that metadata to transform the score (thus penalizing most frequent skills).

After the ranking step is complete, the keys are sorted in each dimension and the network insights system can select the top keys and transform the associated rows into insights. The top keys can be defined as a fixed number N (e.g., 100) or by selecting a score threshold so only rows above a certain score are retained. In one embodiment, network insights follow a generic schema which includes information listed below
The viewee profile identifier (who is this insight about).
An insight type (a simple string that defines the type).
A score between 0 and 1.
A definition of the relationship with the attributes.
The list of connections.
A timestamp (optional, only if the insight type takes the time in account).
A vector of features (for personalization).

The following excerpt in Table 6 provides an example of how the schema is used to store a simple insight that can be displayed to a viewer as the string “Reid has 34 connections who work in Product Management at LinkedIn.”

TABLE 6
// Reid has 34 connections who work in Product Management at LinkedIn
{
“id”: “urn:li:insight:(x,27)”,
“kind”: 2,
“cut”: {
“entityUrns”: [“urn:li:member:1213”],
“relationships”: [
{
“cut”: {
“entityUrns”: [“urn:li:member:1970358”, “...”],
“entityCount”: 34,
“relationships”: [
{“cut”: {“entityUrns”: [“urn:li:function:19”]}},
{“cut”: {“entityUrns”: [“urn:li:company:1337”]}}
]
}
}
]
},
“model”: “s0”,
“score”: 0.76,
“features”: [0.0, 0.1, 0.9, 0.0]
}

The score, in this example, represents how globally interesting the insight is (the higher the score, the more interesting is the insight). E.g., an insight that is about many connections will typically have a higher score than an insight's with fewer connections.

This schema is generic enough to represent a large variety of network insights. In the insight represented by the string “John knows 5 people at Google,” the string “John” is associated with the profile identifier, the relationship is defined by the string “knows,” and the number “5” represents the list of connected profiles that include the value “Google” of the company attribute.

In the insight represented by the string “John has connected with 15 people in the Media industry in Los Angeles in the last 3 months,” the time dimension is added and is equal to 3 months. Another example of an insight that includes a time dimension is “John knows 12 people who recently started working at Microsoft.” Insights are generated for each member profile in the on-line social network and the result is a list made of different types of insights. Some types may be more interesting than others, so a score can be associated to each type so the final list contains a larger number of the best types. As explained above, the types of insights include descriptive insights and comparative insights. Each of these types may be of subtypes related to different profile attributes, such as company attribute, region attribute, etc.

As mentioned above, a network insights system is also configured to generate, for each member profile in the on-line social network, a set of personalization features, which may also be referred to as a feature vector. A feature vector reflects the relevance of each possible value of a certain profile attribute with respect to the member profile. It is generated during a so-called personalization step. The personalization step runs in parallel with step 3 and 4 and is responsible for outputting a vector of features for each member profile. A vector of features may be generated in the form a vector of double numbers, for which columns are attached to specific features. In order to personalize insights for a given viewer, the network insights system uses a similarity score between the viewer and the connections in an insight. This similarity score is computed using multiple features (for example the industry a member is in), each of which corresponds to a double, assembled together in a vector. For example a member with feature vector [0.1, 0.9] would be very similar to a member with feature vector [0.11, 0.91], but less so to a member with feature vector [0.5, 0.4]. This vector of features may also be pushed to the insights database, in addition of the network insights. This data will be retrieved by the online component of the network insights system during the re-ranking step, which is described further below.

The purpose of the personalization step is to prepare the data so insights can be personalized for respective viewers. As seen above, network insights are computed for each member and a single list is produced. However, some insights might be more relevant to some users and therefore the purpose of personalizing them. For instance, if both members U and V are looking at member A's network insights, it may be reasonable to assume U and V might be interested in different sets of insights. For instance, member U might prefer insights about companies in Boston and member V might prefer insights about companies in the San Francisco Bay Area. The solution is to re-rank member A's network insights based on the feature vector of a member who would be viewing the insights. The feature vector for a particular member profile is generated based on the information present in that particular member profile and the information present in respective profiles that are connected to the particular profile in the on-line social network.

In one embodiment, the feature space may be defined based on certain selected profile attributes, such as, e.g., region, industry, and company. The values of the selected attributes are used as representing the members' preferences. For example, if a member lives in New York (the value of the region attribute being “New York”) and works in the health industry (the value of the industry attribute being “health”), it may be inferred that the user is likely to be interested in an insight that highlights information about how their profile is related to the health industry in New York (and not, e.g., to the entertainment industry in Japan). In some embodiments, the network insights system may be configured to capture relationship between regions, industries and companies and infer that a member may be interested in the insights that, e.g., provide information with respect to an industry that is related to the industry they are in. For instance, the same member might be interested in insights that highlight relationships with the health industry in Philadelphia, which is close from New York.

This can be achieved using a matrix factorization technique such as SVD (singular value decomposition). The purpose of SVD is to reduce the number of dimensions from the sparse space of the selected profile attributes (which are, in one example, industries, regions, and companies) to a dense space of K features, where K may be a relatively small number (e.g., 50 or 100). The original matrix takes a sample of member profiles as rows and all the values of each of the selected profile attributes. The cells of the matrix are filled with the number of connections of the member profile identifies by the associated row that have the value of the attribute identified by the respective column. This matrix may be built using the result of the step 2 that was described above, where a profile object was extended to include information about the connections of the associated member profile. After applying SVD on the original matrix, the network insights system may obtain the factorization data in the form of two matrices, which can then be translated into a vector of K features—the feature vector. For the purposes of the purposes of this description, a feature vector generated for a member profile may also be referred to as a set of personalization features. As illustrated, e.g., in Table 6 above, a feature vector generated for a particular member profile may also be associated with each insight generated for that particular member profile.

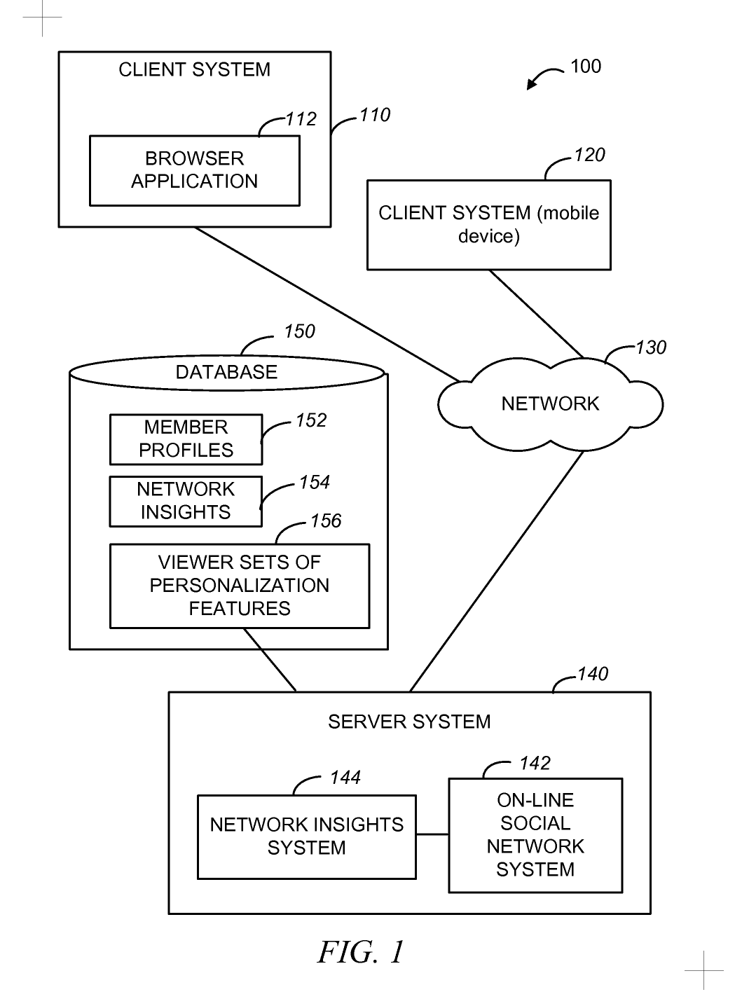

As explained above, the network insights architecture, in one example embodiment, includes an offline component (described above) and also an online component configured to query the insights database and to serve selected network insights. Requests for insights are made by passing two parameters: the identification of a viewer profile and the identification of a viewee profile. When the network insights system detects an indication that one member (a viewer member) should be presented with insights regarding another member (a viewee member), the network insights system fetches the set of insights for the viewee profile and the feature vector for the viewer profile, and re-ranks the set of insights using a personalization function. An indication that a viewer member should be presented with insights regarding a viewee member may be associated, e.g., with the viewer member accessing the viewee member's profile web page or accessing their news feed web page after having recently connected with a member represented by the viewee's profile. The personalization function takes, as input, the feature vectors of respective insights and the feature vector associated with the viewer profile and applies cosine-similarity calculation to each pair of vectors (insight feature vector and viewer feature vector) to generate respective relevance scores for the insights. The output of the personalization function is a list of insights, where the insights in the list are ranked based on their respective relevance scores with respect to the viewing member. Based on their respective relevance scores, the most relevant insights are served for presentation to the member represented by the viewer profile. An example network insights system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

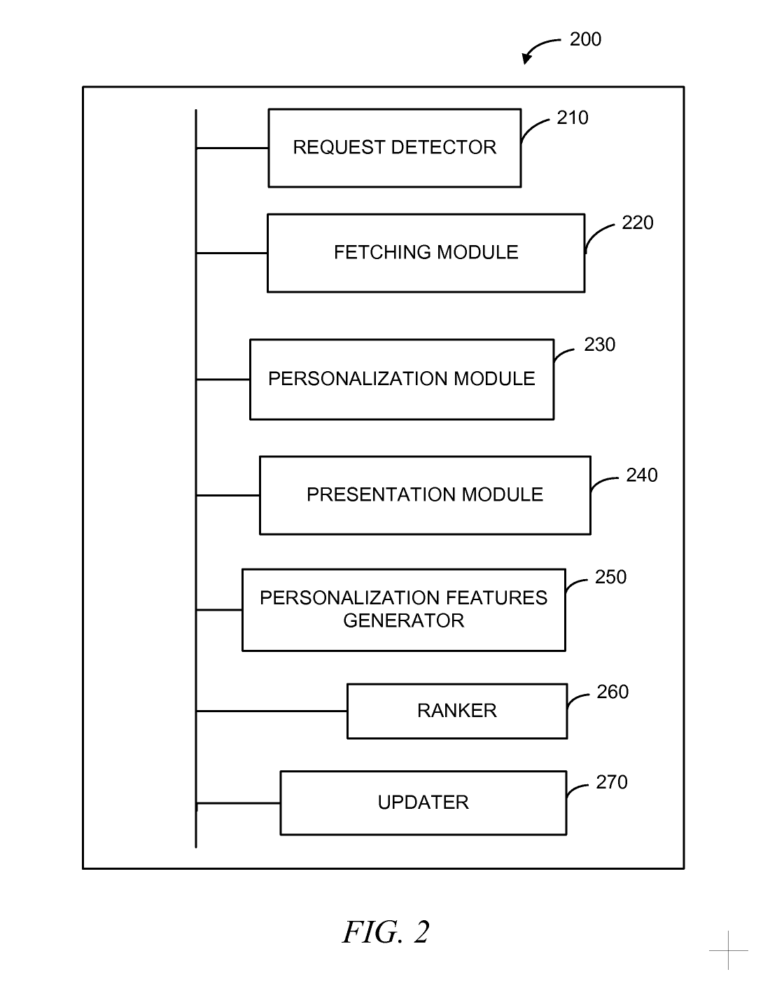

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a network insights system 144. The network insights system 144 may be configured to generate and insights for each member in the on-line social network system 142 and store then in the database 150 as network insights 154. The network insights system 144 also generates a set of personalization features for each member profile in the on-line social network system 144 and stores them in the database 150 as viewer sets of personalization features 156. As explained above, a set of personalization features for a member profile reflects the relevance of each possible value of a certain profile attribute with respect to the member profile. When the network insights system 144 determines that a member (the viewer) is to be presented with one or more insights with respect to another member (the viewee) it determines insights of the viewee for presentation to the viewer on a display device, based on the set of personalization features for the viewer. An example network insights system 144 is illustrated in FIG. 2.

FIG. 2 is a block diagram of a system 200 to produce network insights for a member in an on-line social network system 142 of FIG. 1. As shown in FIG. 2, the system 200 includes a request detector 210, a fetching module 220, a personalization module 230, and a presentation module 240. The request detector 210 may be configured to detect a request indicating a viewer profile and a viewee profile. As explained above, the viewer profile and the viewee profile represent respective members in an on-line social network and include a subject profile attribute (e.g., a company attribute, a region attribute, an industry attribute, etc.). The fetching module 220 may be configured to retrieve, from the database 150, a plurality of insights associated with the viewee profile. An insight from the plurality of insights is generated with respect to the particular value of the subject profile attribute, namely the value of the subject profile attribute that is present in the viewee profile. For example, if the viewee profile indicates that the member represented by the viewee profile is currently employed at LinkedIn, an insight may be generated with respect to the value of the company attribute represented by the string “LinkedIn.” The fetching module 220 is also configured to retrieve, from the database 150, a viewer set of personalization features associated with a member represented by the viewer profile. The viewer set of personalization features reflecting relevance to the viewer profile of each value of the company attribute from the set of values. The personalization module 230 may be configured to generate respective relevance scores for each insight from the plurality of insights based on comparing the viewer set of personalization features with each insight from the plurality of insights, and select insights from the plurality of insights for presentation to a member represented by the viewer profile based on the respective relevance scores. The presentation module 240 may be configured to cause presentation of the selected insights on a display device, e.g., on a profile web page of the viewer or on the news feed web page generated for the viewer.

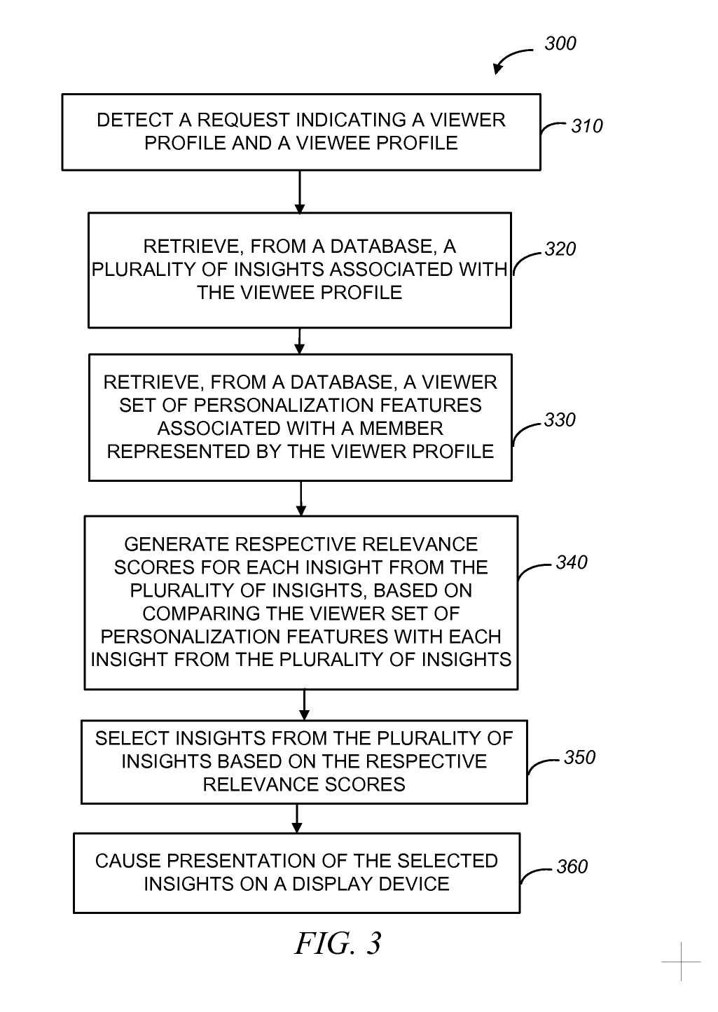

Also shown in FIG. 2 is a personalization features generator 250, a ranker 260, and an updater 270. The personalization features generator 250 may be configured to generate the viewer set of personalization features. A set of personalization features, also referred to as a viewer feature vector may be generated, as explained above, using a matrix factorization technique such as SVD to reduce dimensionality of data that indicates, for each value from the set of possible values of a subject profile attribute, a count of profiles connected to the viewer profile that include a certain value from the set of possible values. The ranker 260 may be configured to select a plurality of insights from a larger set of insights associated with the viewee profile, based on respective importance scores of insights from the larger set. The process of generating respective importance scores for a set of insights of a certain viewee is described above. The updater 270 may be configured to update the plurality of insights, as also described above with reference to a network insights system. Some operations performed by the system 200 may be described with reference to FIG. 3.

FIG. 3 is a flow chart of a method 300 to produce network insights for a member in an on-line social network system 142 of FIG. 1. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the request detector 210 detects a request indicating a viewer profile and a viewee profile. As explained above, the viewer profile and the viewee profile represent respective members in an on-line social network and include a subject profile attribute (e.g., a company attribute, a region attribute, an industry attribute, etc.). The fetching module 220 retrieves, from the database 150, a plurality of insights associated with the viewee profile at operation 320. An insight from the plurality of insights is generated with respect to the particular value of the subject profile attribute, namely the value of the subject profile attribute that is present in the viewee profile. For example, if the viewee profile indicates that the member represented by the viewee profile is currently employed at LinkedIn, an insight may be generated with respect to the value of the company attribute represented by the string “LinkedIn.” At operation 330, the fetching module 220 retrieves, from the database 150, a viewer set of personalization features associated with a member represented by the viewer profile. The viewer set of personalization features reflects relevance of each value of the company attribute from the set of values to the viewer profile. The personalization module 230 generates respective relevance scores for each insight from the plurality of insights based on comparing the viewer set of personalization features with each insight from the plurality of insights, at operation 340 and selects insights from the plurality of insights for presentation to a member represented by the viewer profile based on the respective relevance scores at operation 350. At operation 360, the presentation module 240 causes presentation of the selected insights on a display device, e.g., on a profile web page of the viewer or on the news feed web page generated for the viewer.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

FIG. 5 is a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 505. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to produce network insights for a member in an on-line social network system has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
detecting a request indicating a viewer profile and a viewee profile, the viewer profile and the viewee profile representing respective members in an on-line social network and including a subject profile attribute, the viewee profile indicating a particular value of the subject profile attribute, the particular value being from a set of values;
retrieving, from a database, a plurality of insights associated with the viewee profile, an insight from the plurality of insights generated with respect to the particular value of the subject profile attribute;
retrieving, from the database, a viewer set of personalization features, the viewer set of personalization features reflecting relevance to the viewer profile of each value of from the set of values;
generating, using at least one processor, respective relevance scores for each insight from the plurality of insights based on comparing the viewer set of personalization features with each insight from the plurality of insights;
based on the respective relevance scores, selecting insights from the plurality of insights for presentation to a member represented by the viewer profile; and
causing presentation of the selected insights on a display device.

2. The method of claim 1, wherein an insight from the plurality of insights includes data indicating a count of profiles connected to the viewee profile that include the particular value of the subject profile attribute.

3. The method of claim 1, wherein an insight from the plurality of insights includes data reflecting a comparison of the viewer profile and the viewee profile with respect to the particular value of the subject profile attribute.

4. The method of claim 1, wherein the particular value of the subject profile attribute is associated with a time stamp.

5. The method of claim 1, comprising generating the viewer set of personalization features, the generating comprising reducing dimensionality of data that indicates, for each value from the set of values, a count of profiles connected to the viewer profile that include a value from the set of values.

6. The method of claim 1, wherein the retrieving of the plurality of insights comprises selecting the plurality of insights from a larger set of insights associated with the viewee profile, based on respective importance scores of insights from the larger set.

7. The method of claim 1, comprising updating the plurality of insights.

8. The method of claim 1, wherein the subject profile attribute indicates region information, industry information, or company information.

9. The method of claim 1, wherein the causing of the presentation of the selected insights on the display device comprises including the selected insights on a profile web page of the member represented by the viewee profile.

10. The method of claim 1, wherein the causing of the presentation of the selected insights on the display device comprises including the selected insights on a news feed web page of the member represented by the viewer profile.

11. A computer-implemented system comprising:
a request detector, implemented using at least one processor, to detect a request indicating a viewer profile and a viewee profile, the viewer profile and the viewee profile representing respective members in an on-line social network and including a subject profile attribute, the viewee profile indicating a particular value of the subject profile attribute, the particular value being from a set of values;
a fetching module, implemented using at least one processor, to:
retrieve, from a database, a plurality of insights associated with the viewee profile, an insight from the plurality of insights generated with respect to the particular value of the subject profile attribute, and
retrieve, from the database, a viewer set of personalization features, the viewer set of personalization features reflecting relevance to the viewer profile of each value of from the set of values;
a personalization module, implemented using at least one processor, to:
generate respective relevance scores for each insight from the plurality of insights based on comparing the viewer set of personalization features with each insight from the plurality of insights, and
select insights from the plurality of insights for presentation to a member represented by the viewer profile based on the respective relevance scores; and
a presentation module, implemented using at least one processor, to cause presentation of the selected insights on a display device.

12. The system of claim 11, wherein an insight from the plurality of insights includes data indicating a count of profiles connected to the viewee profile that include the particular value of the subject profile attribute.

13. The system of claim 11, wherein an insight from the plurality of insights includes data reflecting a comparison of the viewer profile and the viewee profile with respect to the particular value of the subject profile attribute.

14. The system of claim 11, wherein the particular value of the subject profile attribute is associated with a time stamp.

15. The system of claim 11, comprising a personalization features generator, implemented using at least one processor, to generate the viewer set of personalization features, the generating comprising reducing dimensionality of data that indicates, for each value from the set of values, a count of profiles connected to the viewer profile that include a value from the set of values.

16. The system of claim 11, comprising a ranker, implemented using at least one processor, to select the plurality of insights from a larger set of insights associated with the viewee profile, based on respective importance scores of insights from the larger set.

17. The system of claim 11, comprising an updater, implemented using at least one processor, to updat the plurality of insights.

18. The system of claim 11, wherein the subject profile attribute indicates region information, industry information, or company information.

19. The system of claim 11, wherein the presentation module is to include the selected insights on a profile web page of the member represented by the viewee profile.

20. A machine-readable non-transitory storage medium having instruction data executable by a machine to cause the machine to perform operations comprising:
detecting a request indicating a viewer profile and a viewee profile, the viewer profile and the viewee profile representing respective members in an on-line social network and including a subject profile attribute, the viewee profile indicating a particular value of the subject profile attribute, the particular value being from a set of values;
retrieving, from a database, a plurality of insights associated with the viewee profile, an insight from the plurality of insights generated with respect to the particular value of the subject profile attribute;
retrieving, from the database, a viewer set of personalization features, the viewer set of personalization features reflecting relevance to the viewer profile of each value of from the set of values;
generating respective relevance scores for each insight from the plurality of insights based on comparing the viewer set of personalization features with each insight from the plurality of insights;
based on the respective relevance scores, selecting insights from the plurality of insights for presentation to a member represented by the viewer profile; and
causing presentation of the selected insights on a display device.
